(19) United States
(12) Patent Application Publication
(10) Pub. No.: US 2013/0051595 A1
(43) Pub. Date: Feb. 28, 2013

(54) ELECTRONIC DEVICE WITH SOUND CHAMBER

(71) Applicants: HE-HUI YANG, Shenzhen City (CN); YONG-HUI HU, Shenzhen City (CN); KAI-KUEI WU, Tu-Cheng (TW); KUN-CHIH HSIEH, Tu-Cheng (TW)

(72) Inventors: HE-HUI YANG, Shenzhen City (CN); YONG-HUI HU, Shenzhen City (CN); KAI-KUEI WU, Tu-Cheng (TW); KUN-CHIH HSIEH, Tu-Cheng (TW)

(73) Assignees: HON HAI PRECISION INDUSTRY CO., LTD., TU-CHENG (TW); HONG FU JIN PRECISION INDUSTRY (SHENZHEN) CO., LTD., SHENZHEN CITY (CN)

(21) Appl. No.: 13/316,459

(22) Filed: Dec. 10, 2011

(30) Foreign Application Priority Data
Aug. 22, 2011 (CN) 201110241337.8

(51) Int. Cl. H04R 1/02

(52) U.S. Cl. 381/332

(57) ABSTRACT

An electronic device includes an enclosure, a speaker fixed in the enclosure, and a rubber element. The enclosure defines an exposed slot, and a speaker receiving chamber communicating with the slot. The speaker includes a first surface and a opposite second surface. The speaker is configured for radiating sound at the first surface. The rubber element includes a main body a recess and a through hole penetrating through a bottom of the recess. The speaker is inserted in the recess with the first surface facing the bottom of the recess. The combined the speaker and the rubber element are engagingly received in the speaker receiving chamber.

### BACKGROUND

1. Technical Field

The present disclosure relates to electronic devices, and particularly, to an electronic device with a sound chamber.

2. Description of Related Art

Electronic devices such as digital photo frames, tablet computers, electronic books, mobile phones, and MP3 players typically include a speaker. The electronic devices usually include a enclosure, and a middle frame fixed in the enclosure and defining a chamber. The speaker is fixed on the middle frame and faces the chamber. The speaker together with the enclosure and the middle frame define a front chamber and a back chamber. Foam is arranged between the enclosure and the middle frame to seal the front and the back chambers. However, gluing the foam increases the difficulty of assembly, and furthermore, usually causes unsatisfactorily sound due to poor sealing.

Therefore, what is needed is an electronic device alleviating the limitations described above.

### BRIEF DESCRIPTION OF THE DRAWINGS

The components in the drawings are not necessarily drawn to scale, the emphasis instead being placed upon clearly illustrating the principles of an electronic device with a sound chamber. Moreover, in the drawings, like reference numerals designate corresponding parts throughout the several views.

FIG. 1 is an isometric view of an exemplary embodiment of an electronic device with a sound chamber.

FIG. 2 is an exploded view of the electronic device of FIG. 1.

FIG. 3 is similar to FIG. 2, but viewed from another perspective.

FIG. 4 is a partial, cross-sectional view of the electronic device of FIG. 1.

### DETAILED DESCRIPTION

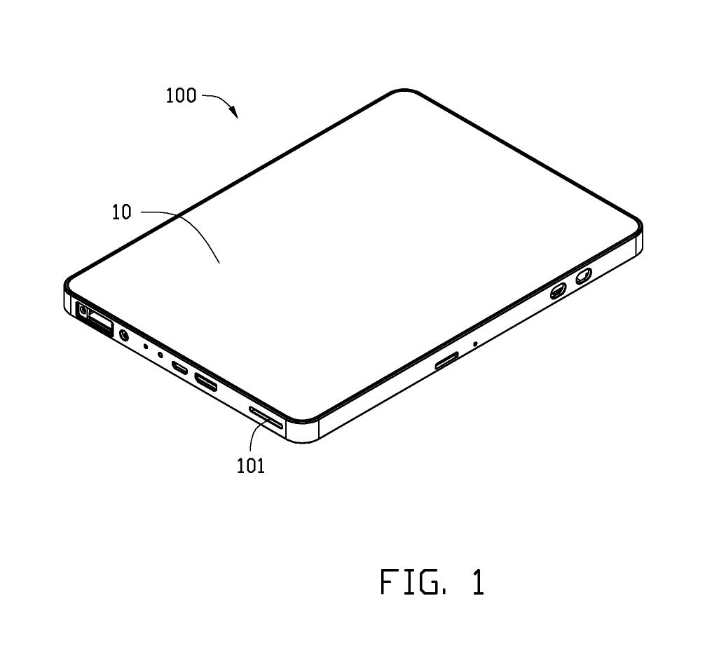

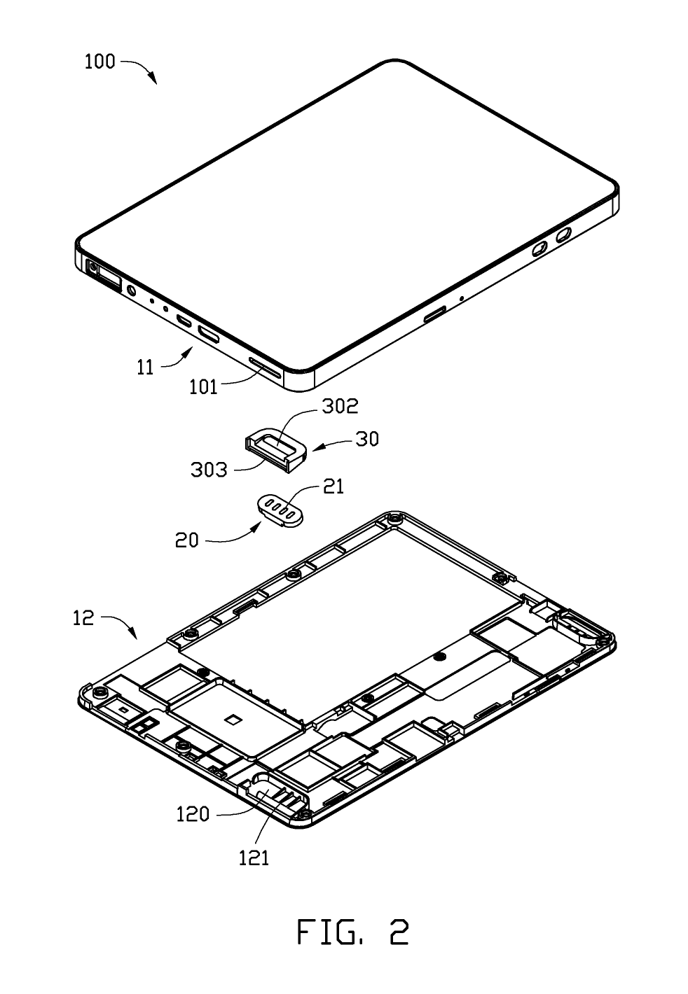

Referring to FIGS. 1 and 2, an electronic device 100 is disclosed as an exemplary embodiment. The electronic device 100 includes a enclosure 10 defining an exposed slot 101, a speaker 20 fixed in the enclosure 10, and a rubber element 30 received in the enclosure 10. The electronic device 100 is an electronic reader. In an alternative embodiment, the electronic device 100 can be a mobile phone, a tablet computer, or a music player.

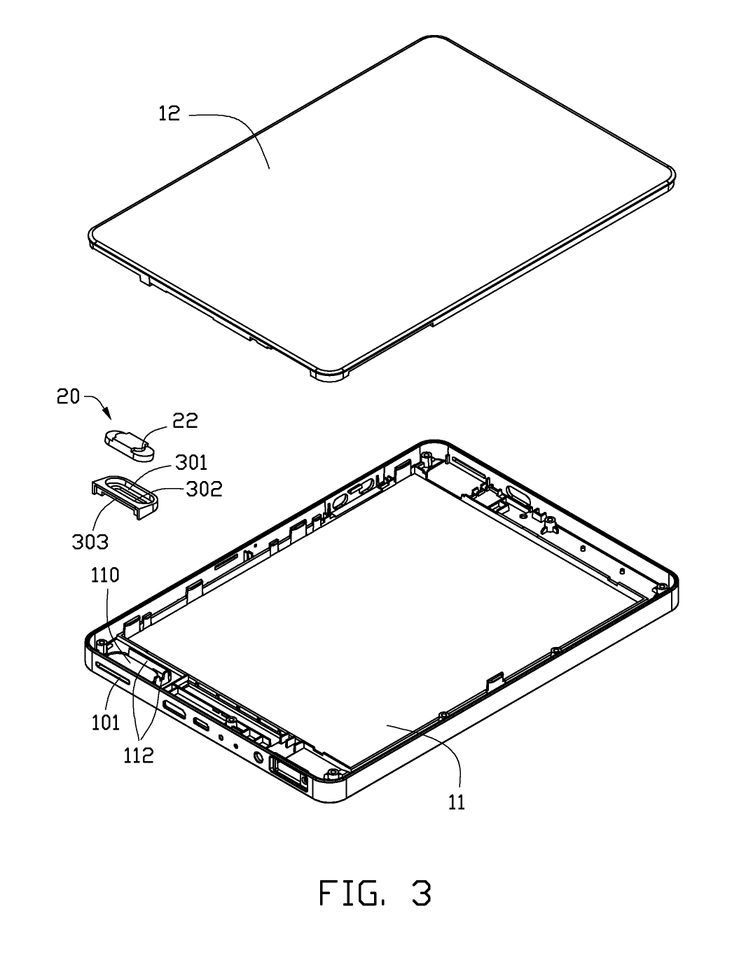

Referring to FIGS. 2 and 3, the enclosure 10 includes an upper cover 11 and a lower cover 12 fixed to the upper cover 11. The lower cover 12 defines a rectangular space 120. A support member 121 for supporting the speaker 20 protrudes from the bottom of the space 120. The slot 101 is defined in the sidewall of the upper cover 11. The upper cover 11 further defines a receiving space 110 located corresponding to the space 120, for receiving the rubber element 30. A restricting member 112 vertically protrudes from an edge of the receiving space 110.

The speaker 20 includes a first surface 21 through which the produced sound passes, and a second, opposite surface 22 electrically connected to a circuit board (not shown) of the electronic device 100. The first surface 21 faces the receiving space 110, and the second surface 22 is received in the space 120.

The rubber element 30 is fixed between the space 120 and the receiving space 110. The rubber element 30 includes a main body defining a recess 301 and a through hole 302 penetrating through the bottom of the recess 301. The shape of the recess 301 matches with that of the contour of the first surface 21, allowing the speaker 20 to be received in the recess 301. An engaging ridge 303 protrudes from one side of the rubber element 30, and cooperates with the sidewalls of the upper cover 11 and the lower cover 12 to position the rubber element 30 and to seal a sound chamber 14 defined by the space 120, the receiving space 110 and the enclosure 10. The sound chamber 14 includes a front chamber 114 and a back chamber 124. In this embodiment, materials with good sealing ability integrally form the rubber element 30. The sound chamber 14 is a speaker receiving chamber.

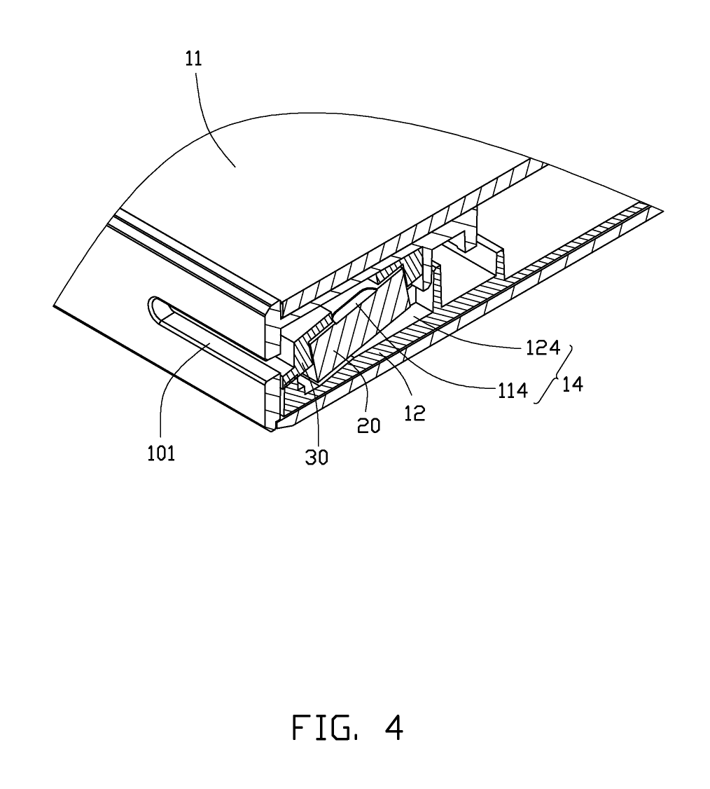

During assembly, the speaker 20 is first received in the rubber element 30. The speaker 20 together with the rubber element 30 is then fixed to the lower cover 12. The upper cover 11 is finally connected to the lower cover 12. In the embodiment, the first surface 21 rests on the bottom of the recess 301. The rubber element 30 together with the speaker 20 is fixed to the space 120 of the lower cover 12. The second surface 22 of the speaker 20 resists against the support member 121, and the engaging ridge 303 resists against the sidewall of the space 120. The receiving space 110 of the upper cover 11 is orientated to align the rubber element 30 with the restricting member 112 resisting on the sidewall of the rubber element 30, and the portions of the rubber element 30, which are exposed out of the space 120, and are received in the receiving space 110. Finally, the upper cover 11 is connected to the lower cover 12. As shown in FIG. 4, the rubber element 30 and the speaker 20 together separate the sound chamber 14 into the front chamber 114 and the back chamber 124. The front chamber 114 is defined between the speaker 20 and the upper cover 11. The back chamber 124 is defined between the speaker 20 and the lower cover 12.

With such a configuration, compared with the conventional sealing techniques using a foam, the electronic device 100 has an advantage of ease of assembly by using the rubber element 30. The rubber element 30 can also seal the front and back chambers 114, 124, which improves the seals performance and thus emits better sound.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
an enclosure defining an exposed slot, and a speaker receiving chamber communicating with the slot;
a speaker comprising a first surface and an opposite second surface, the speaker being configured for radiating sound at the first surface; and
a rubber element comprising a main body defining a recess and a through hole penetrating through a bottom of the recess, the speaker inserted in the recess with the first surface facing the bottom of the recess, the combined the speaker and the rubber element being engagingly received in the speaker receiving chamber.

2. The electronic device as described in claim 1, wherein the enclosure comprises an upper cover and a lower cover connected to the upper cover, the combined the speaker and the rubber element separate the speaker receiving chamber into a front chamber communicating with the slot and a back chamber isolating from the front chamber, the front chamber is bounded by the speaker and the upper cover, and the back chamber is bounded by the speaker and the lower cover.

3. The electronic device as described in claim 1, wherein the rubber element includes an engaging ridge protruding from the main body for engaging with the enclosure so as to retainably received in the speaker receiving chamber.

4. The electronic device as described in claim 1, wherein a support member is formed in the speaker receiving chamber for supporting the second surface of the speaker.

5. The electronic device as described in claim 1, wherein a circuit board received in the enclosure and the second surface of the speaker faces toward the circuit board.

6. The electronic device as described in claim 1, wherein the electronic device is a device selected from the group consisting of an electronic reader, a mobile phone, a tablet computer, and a music player.
